(19) United States
(12) Patent Application Publication
(10) Pub. No.: US 2004/0166912 A1
(43) Pub. Date: Aug. 26, 2004

(54) Device for interacting with real-time streams of content

(76) Inventor: Marcelle Andrea Stienstra, Eindhoven (NL)

Correspondence Address: Philips Electronics North America Corporation, Corporate Patent Counsel, PO Box 3001, Briarcliff Manor, NY, 10510, US

(21) Appl. No.: 10/477,495

(22) PCT Filed: May 14, 2002
(86) PCT No.: PCT/IB02/01664

(30) Foreign Application Priority Data
May 14, 2001 (EP) 01201796.8

(51) Int. Cl. A63F 13/00

(52) U.S. Cl. 463/1

(57) ABSTRACT

An end-user system (10) for transforming real-time streams of content into an output presentation includes an input device (30) that allows a user to interact with the streams. The input device (30) includes sensors (330) for detecting manipulations of the input device (30) by the user, and a microprocessor (310) for determining how the user manipulated the input device (30). The microprocessor (310) indicates the detected manipulations to the end-user system (10). The end-user system (10) accordingly activates or deactivates certain streams of content in the output presentation. The input device (30) can have a simple form and the manipulations required can be quite simple, such as rolling, rotating, or bouncing the input device (30). The present invention allows a user to adapt the output presentation according to his/her own preferences, instead of merely being a spectator.

The present invention relates to a system and method for receiving and displaying real-time streams of content Specifically, the present invention enables a user to interact with and personalize the displayed real-time streams of content.

Storytelling and other forms of narration have always been a popular form of entertainment and education. Among the earliest forms of these are oral narration, song, written communication, theater, and printed publications. As a result of the technological advancements of the nineteenth and twentieth century, stories can now be broadcast to large numbers of people at different locations. Broadcast media, such as radio and television, allow storytellers to express their ideas to audiences by transmitting a stream of content, or data, simultaneously to end-user devices that transforms the streams for audio and/or visual output.

Such broadcast media are limited in that they transmit a single stream of content to the end-user devices, and therefore convey a story that cannot deviate from its predetermined sequence. The users of these devices are merely spectators and are unable to have an effect on the outcome of the story. The only interaction that a user can have with the real-time streams of content broadcast over television or radio is switching between streams of content, i.e., by changing the channel. It would be advantageous to provide users with more interaction with the storytelling process, allowing them to be creative and help determine how the plot unfolds according to their preferences, and therefore make the experience more enjoyable.

At the present time, computers provide a medium for users to interact with real-time streams of content. Computer games, for example, have been created that allow users to control the actions of a character situated in a virtual environment, such as a cave or a castle. A player must control his/her character to interact with other characters, negotiate obstacles, and choose a path to take within the virtual environment. In on-line computer games, streams of real-time content are broadcast from a server to multiple personal computers over a network, such that multiple players can interact with the same characters, obstacles, and environment. While such computer games give users some freedom to determine how the story unfolds (i.e., what happens to the character), the story tends to be very repetitive and lacking dramatic value, since the character is required to repeat the same actions (e.g. shooting a gun), resulting in the same effects, for the majority of the game's duration.

Various types of children's educational software have also been developed that allows children to interact with a storytelling environment on a computer. For example, LivingBooks® has developed a type of “interactive book” that divides a story into several scenes, and after playing a short animated clip for each scene, allows a child to manipulate various elements in the scene (e.g., “point-and-click” with a mouse) to play short animations or gags. Other types of software provide children with tools to express their own feelings and emotions by creating their own stories. In addition to having entertainment value, interactive storytelling has proven to be a powerful tool for developing the language, social, and cognitive skills of young children.

However, one problem associated with such software is that children are usually required to using either a keyboard or a mouse in order to interact. Such input devices must be held in a particular way and require a certain amount of hand-eye coordination, and therefore may be very difficult for younger children to use. Furthermore, a very important part of the early cognitive development of children is dealing with their physical environment. An interface that encourages children to interact by “playing” is advantageous over the conventional keyboard and mouse interface, because it is more beneficial from an educational perspective, it is more intuitive and easy to use, and playing provides a greater motivation for children to participate in the learning process. Also, an interface that expands the play area (i.e., area in which children can interact), as well as allowing children to interact with objects they normally play with, can encourage more playful interaction.

ActiMates™ Barney™ is an interactive learning product created by Microsoft Corp.®, which consists of a small computer embedded in an animated plush doll. A more detailed description of this product is provided in the paper, E. Strommen, “When the Interface is a Talking Dinosaur: Learning Across Media with ActiMates Barney,” Proceedings of CHI '98, pages 288-295. Children interact with the toy by squeezing the doll's hand to play games, squeezing the doll's toe to hear songs, and covering the doll's eyes to play “peek-a-boo.” ActiMates Barney can also receive radio signals from a personal computer and coach children while they play educational games offered by ActiMates software. While this particular product fosters interaction among children, the interaction involves nothing more than following instructions. The doll does not teach creativity or collaboration, which are very important in the developmental learning, because it does not allow the child to control any of the action.

CARESS (Creating Aesthetically Resonant Environments in Sound) is a project for designing tools that motivate children to develop creativity and communication skills by utilizing a computer interface that converts physical gestures into sound. The interface includes wearable sensors that detect muscular activity and are sensitive enough to detect intended movements. These sensors are particularly useful in allowing physically challenged children to express themselves and communicate with others, thereby motivating them to participate in the learning process. However, the CARESS project does not contemplate an interface that allows the user any type of interaction with streams of content.

It is an object of the present invention to allow users to interact with real-time streams of content received at an end-user device. This object is achieved according to the present invention in an input device as claimed in claim 1. Real-time streams of content are transformed into a presentation that is output to the user by an output device, such as a television or computer display. The presentation can convey a narrative whose plot unfolds according to the transformed real-time streams of content, and the user's interaction with these streams of content helps determine the outcome of the story by activating or deactivating streams of content, or by modifying the information transported in these streams. The input device allows users to interact with the real-time streams of content in a simple, direct, and intuitive manner. The input device provides users with physical, as well as mental, stimulation while interacting with real-time streams of content.

One embodiment of the present invention is directed to a system that transforms real-time streams of content into a presentation to be output and an input device that is manipulated by a user in order to activate or deactivate streams of content within the presentation. The input device includes a plurality of sensors that detect the user's manipulation of the device, and a microprocessor for processing the sensor signals into a coded signal representative of the specific manner in which the user has manipulated the device. The input device further includes a transmission unit for transmitting the encoded signal to the end-user device, which maps the coded signal to one or more streams of content to be activated or deactivated.

In another embodiment of the present invention, the sensors of the input device include a light sensor that detects a change in the intensity of light striking the sensor.

In another embodiment of the present invention, the sensors of the input device include a touch sensor that detects an amount of force being applied to the surface of the device, and the surface location at which force is being applied.

In another embodiment of the present invention, the sensors of the input device include a rotation sensor that detects a rotational movement of the device. The rotation sensor according to this embodiment may be capable of detecting the direction at which the device is rotated, the number of times the device is rotated (or the angle through which the device rotates), and the angular velocity at which the device rotates.

In another embodiment of the present invention, the input device takes the form of a ball, and the user may throw, bounce, shake, or roll the input device in order to activate or deactivate a stream of content.

In another embodiment of the present invention, the input device takes the form of a ball divided into two hemispheres, and the user may manipulate the input device by rotating one of the hemispheres in a certain direction with respect to the other hemisphere in order to activate or deactivate a stream of content.

Another embodiment of the present invention is directed to a method of transforming real-time streams of content into a presentation, in which a user activates and deactivates streams of content through the input device.

These and other embodiments of the present invention will become apparent from and elucidated with reference to the following detailed description considered in connection with the accompanying drawings.

It is to be understood that these drawings are designed for purposes of illustration only and not as a definition of the limits of the invention for which reference should be made to the appending claims.

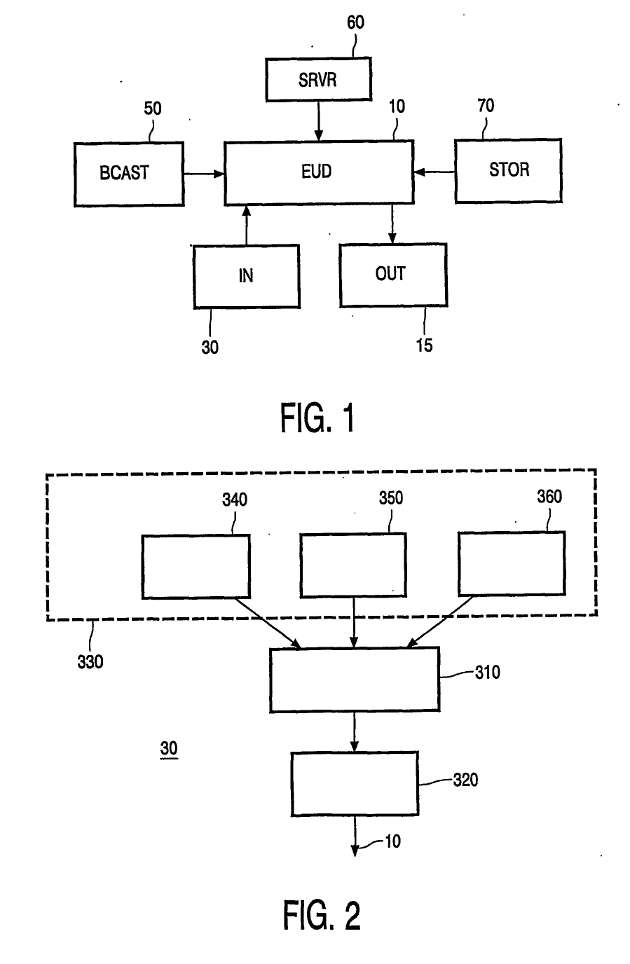

FIG. 1 is a block diagram illustrating the configuration of a system for transforming real-time streams of content into a presentation.

FIG. 2 is a block diagram illustrating the configuration of the input device according to an exemplary embodiment.

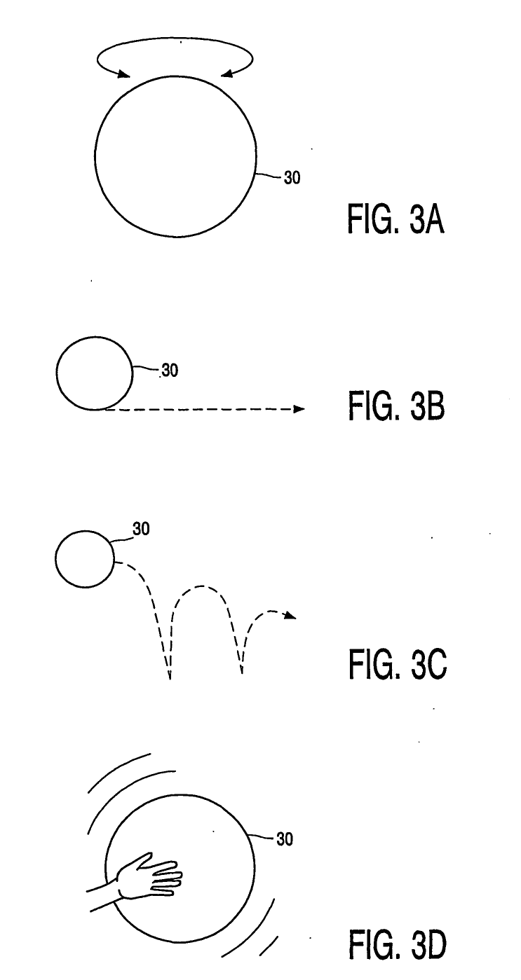

FIGS. 3A, 3B, 3C, and 3D illustrate examples of the manipulation of an input device taking the form of a ball.

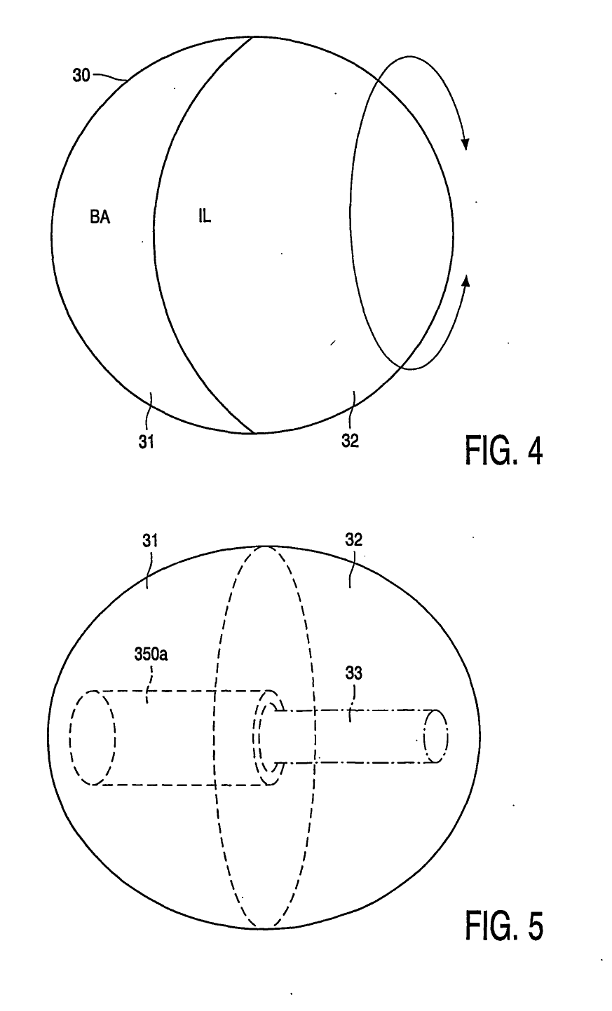

FIG. 4 illustrates an example of the manipulation of an input device taking the form of a ball divided into two hemispheres.

FIG. 5 illustrates a rotational sensor used in connection with the input device shown in FIG. 4.

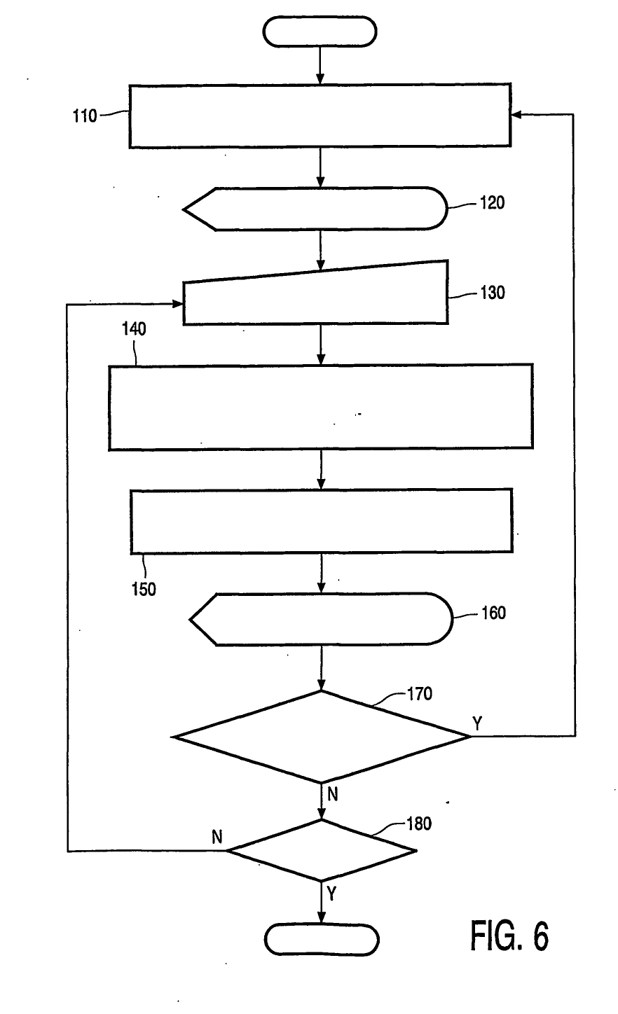

FIG. 6 is a flowchart illustrating the method whereby real-time streams of content can be transformed into a narrative.

Referring to the drawings, FIG. 1 shows a configuration of a system for transforming real-time streams of content into a presentation, according to an exemplary embodiment of the present invention. An end-user device 10 receives real-time streams of data, or content, and transforms the streams into a form that is suitable for output to a user on output device 15. The end-user device 10 can be configured as either hardware, software being executed on a microprocessor, or a combination of the two. One possible implementation of the end-user device 10 and output device 15 of the present invention is as a set-top box that decodes streams of data to be sent to a television set. The end-user device 10 can also be implemented in a personal computer system for decoding and processing data streams to be output on the CRT display and speakers of the computer. Many different configurations are possible, as is known to those of ordinary skill in the art.

The real-time streams of content can be data streams encoded according to a standard suitable for compressing and transmitting multimedia data, for example, one of the Moving Picture Experts Group (MPEG) series of standards. However, the real-time streams of content are not limited to any particular data format or encoding scheme. As shown in FIG. 1, the real-time streams of content can be transmitted to the end-user device over a wire or wireless network, from one of several different external sources, such as a television broadcast station 50 or a computer network server 60. Alternatively, the real-time streams of data can be retrieved from a data storage device 70, e.g. a CD-ROM, floppy-disc, or Digital Versatile Disc (DVD), which is connected to the end-user device.

As discussed above, the real-time streams of content are transformed into a presentation to be communicated to the user via output device 15. In an exemplary embodiment of the present invention, the presentation conveys a narrative to the user. Unlike prior art systems that merely convey a story whose plot is predetermined by the real-time streams of content, the present invention allows the user to interact with the narrative presentation and help determine its outcome by manipulating an input device 30. According to these manipulations, the user activates or deactivates streams of content associated with the presentation. For example, each stream of content may cause the story to follow a particular storyline, and the user determines how the plot unfolds by activating a particular stream, or storyline. Therefore, the present invention allows the user to exert creativity and personalize the story according to his/her own wishes. However, the present invention is not limited to transforming real-time streams of content into a story to be presented to the user. According to other exemplary embodiments of the present invention, the real-time streams can be used to convey songs, poems, musical compositions, games, virtual environments, adaptable images, or any other type of content with which the user can adapt according to his/her personal wishes.

As mentioned above, FIG. 2 shows in detail the input device 30 including one or more sensors 330 and a microprocessor 310. The sensors 330 detect the user's manipulations of the input device 30, and output their detection signals to the microprocessor. The microprocessor 310 then maps these detection signals to a manipulation code. The manipulation code is any type of word, number, symbol, or signal that indicates the manner in which the input device 30 has been manipulated (e.g., rotated, bounced, etc.).

After mapping the detection signals to a manipulation code, the microprocessor 310 sends this code to a transmitter 320, which formats and transmits the code to the end-user device 15 via radio signals, wires, or other type of communications link. Once received, the end-user device 15 then decodes the manipulation code to determine the manner in which the input device 30 has been manipulated, and activates or deactivates one or more streams of content corresponding to the determined type of manipulation.

According to an exemplary embodiment, the sensors 330 include one or more of a touch sensor 340, a rotation sensor 350, and a light sensor 360. Each of these types of sensors will be described in more detail below.

The touch sensor 340 can detect whether or not a user or another object has made contact with the input device 30 by detecting the amount pressure of force that is pressing against the surface of the input device. The touch sensor 340 may comprise one or more capacitive pressure sensors placed on the surface of the input device. Capacitive pressure sensors include two metal plates separated by a layer of non-conductive foam, which form a capacitor. If any type of force is exerted on this sensor, the spacing between the plates decreases, causing a difference in the capacitance. The capacitor, together with a conductor, determines the frequency of an oscillator. Therefore, the amount of pressure being exerted can be determined according to changes in frequency of the oscillator.

The touch sensor 340 may further include an elastomer pressure sensor, which includes a foam pad (elastomer) placed at the surface of the input device 30. The resistance of the foam pad varies depending on how much it is compressed. When a voltage is applied to the pad, electrodes can sense a change in the current in a particular region of the pad in order to determine the amount and location of the pressure being applied. However, many other types of touch or pressure sensors can be used in connection with the present invention, as will be obvious to one of ordinary skill in the art.

The rotation sensor 350 can detect a rotational movement of the input device 30. For instance, the rotation sensor 350 may measure the number of times, or the number of degrees, that the input device 30 has been rotated about an axis. The direction of rotation may also be detected, as well as the angular velocity at which the input device 30 has been rotated about the axis. The rotation sensor 350 may further be able to detect the number of times a portion of the input device 30 has been rotated, by detecting the number of times an axle fixed to that portion turns.

The light sensor 360, or photosensor, detects the presence and/or intensity of visible light, infrared radiation, and/or ultraviolet energy striking its surface. Most light sensors include a semiconductor device, which includes a material whose electrical conductance varies depending on the intensity of radiation striking the material. Such devices include photodiodes, phototransistors, and photoFETs. Light sensors generate an electric signal corresponding to the amount or intensity of light being sensed. Therefore, the light sensor 350 can detect a change in the intensity of light by detecting changes in the generated electric signal. Such light sensors, especially passive infrared (PIR) sensors may be used to detect whether a user is even approaching the input device, by detecting changes in the infrared radiation of the environment being caused by a person's presence.

The light sensor 350 of the present invention may include one or more photosensors distributed along the surface of the input device 30. Solid-state image sensors, such as Charged-Coupled Devices (CCD), may be used, as well as many other different types of light sensors that are known in the art.

Although FIG. 2 shows touch sensor 340, rotation sensor 350, and light sensor 360, it will be clear to those of ordinary skill in the art that the sensors 330 of the input device 30 may include many other types of sensors for sensing or detecting many other physical properties, in order to detect a manipulation of the input device 30. Such sensors may include heat sensors, active or passive motion sensors, and sound detectors or transducers.

A user may manipulate the input device 30 in a variety of ways, depending on the stream or streams that the user wishes to activate or deactivate in the presentation. According to an exemplary embodiment, the input device 30 is an object that is small and light enough so that it can be easily lifted and handled by small children. The input device 30 may be a toy that children are familiar with, such as a ball, a toy car or airplane, a doll, or a video game joystick. This list is not exhaustive, and the input device 15 can be any type of object that a user can manipulate in a variety of ways.

FIGS. 3A-3D show different distinguishable ways that the input device 30 can be manipulated in order to activate or deactivate streams of content. These figures illustrate an exemplary embodiment where the input device 30 takes the form of a ball. FIG. 3A shows rotation of the input device 30 in a certain direction. FIG. 3B shows the input device 30 being rolled. FIG. 3C shows the input device 30 being bounced. FIG. 3D shows the input device 30 being shaken.

The microprocessor 310 can differentiate between these different types of manipulations by analyzing the output from sensors 330. For example, a detection signal indicating rotation in a particular direction may indicate the rotating of FIG. 3A. On the other hand, such a detection signal in conjunction with a sequence of detection signals occurring along a perimeter of the surface may indicate the rolling of FIG. 3B. Further, a sequence of intermittent detection signals indicating pressure on the surface may indicate the bouncing of FIG. 3C. Also, a rapid succession of detection signals indicating small rotations whose directions are alternating may indicate the shaking of FIG. 3D. In addition, detection signals indicating the sudden absence or reduction of visible light being sensed may indicate to the microprocessor 310 another type of manipulation, such as the input device 30 being covered by a cloth (not shown in the figures).

FIG. 4 illustrates another exemplary embodiment where the input device 30 has the form of a ball divided into two hemispheres 31 and 32. In this embodiment, rotation of hemisphere 32 in a certain direction with respect to the other hemisphere 31 constitutes a type of manipulation. FIG. 5 illustrates this embodiment in more detail. The input device 30 includes an axle 33 that is fixed with respect to the surface of hemisphere 32. This axle 33 is inserted into rotation sensor 350a, which detects the direction and number of turns of the axle 33. While FIGS. 4 and 5 show this type of manipulation being performed on an input device 30 taking the form of a ball of different hemispheres, it will be clear to one of ordinary skill in the art that similar manipulations can be performed and detected when the input device 30 takes on different forms, for example, a doll having a movable head and arms, or the crank on a wind-up toy.

After the microprocessor 310 determines that a recognizable type of manipulation has occurred to the input device 30, according to the detection signals, it maps the corresponding type of manipulation to the corresponding manipulation code. The microprocessor 310 then controls the transmitter 320 to send the manipulation code to the end-user device 10.

The end-user device 10 determines which streams of content should be activated or deactivated according to the received manipulation code. In an exemplary embodiment, each manipulation code is linked to a particular real-time stream of content. The streams of content received by the end-user device 10 may include control data that indicates the manipulation code to which each stream is to be linked.

For example, if a particular manipulation code is received and the corresponding stream is not active, then end-user device 10 may activate the stream. However, if the corresponding stream is already active in the presentation, the end-user device 10 may deactivate the stream. Conversely, variations of the same manipulation may cause the corresponding stream to be activated or deactivated. For example, rotating the input device 30 in a particular direction may cause activation of the stream, while rotating the device in the opposite direction may cause deactivation of the stream.

In an exemplary embodiment, the end-user device 10 will cause instructions to be output to the user that indicate which types of manipulations will activate or deactivate each stream of content. For example, the output device 15 may output a visual or audio message that tells the user that bouncing the ball (input device 30) will initiate a new narrative presentation. Another message may convey to the user that rolling the ball will cause a character in the presentation, such as a prince to move, while shaking the ball will cause the prince to dance.

According to another exemplary embodiment, a stream of content may be activated or deactivated according to a combination of different types of manipulations occurring to the input device 30. In such an embodiment, if the end-user device 10 determines that a certain sequence of manipulation codes has been received, it can activate or deactivate a particular stream of content.

According to another exemplary embodiment, control data may be provided with the real-time streams of content received at the end-user device 10 that cause certain streams of content to be automatically activated or deactivated. This allows the creator(s) of the real-time streams of content to have some control over what streams of content are activated and deactivated. For example, the author(s) of a story has a certain amount of control as to how the plot unfolds by activating or deactivating certain streams of content according to control data within the transmitted real-time streams of content.

Another exemplary embodiment of the present invention includes multiple input devices 30 that are manipulated by one or more users. In this embodiment, each input device 30 may be capable of activating and deactivating the same streams of content according to the same manipulations. Conversely, each input device 30 may be given permission only to activate or deactivate certain streams of content. For example, the manipulation codes transmitted from each input device 30 may include a prefix or suffix is unique for that particular device. When the end-user device 10 decodes the received manipulation codes, only streams of content that correspond to the unique prefix or suffix will be activated or deactivated. Further, each input device 30 may represent a particular stream of content that is modified according to the manipulation code transmitted.

As described above, an exemplary embodiment of the present invention is directed to an end-user device that transforms real-time streams of content into a narrative that is presented to the user through output device 15. One possible implementation of this embodiment is an interactive television system. The end-user device 10 can be implemented as a set-top box, and the output device 15 is the television set. The process by which a user interacts with such a system is described below in connection with the flowchart of FIG. 6.

In step 110, the end-user device 10 receives a stream of data corresponding to a new scene of a narrative and immediately processes the stream of data to extract scene data. Each narrative presentation includes a series of scenes. Each scene comprises a setting in which some type of action takes place. Further, each scene has multiple streams of content associated therewith, where each stream of content introduces or changes an element that affects the plot.

For example, activation of a stream of content may cause a character to perform a certain action (e.g., a prince starts walking in a certain direction), cause an event to occur that affects the setting (e.g., thunderstorm, earthquake), or introduce a new character to the story (e.g., frog). Conversely, deactivation of a stream of content may cause a character to stop performing a certain action (e.g., prince stops walking), terminate an event (e.g., thunderstorm or earthquake ends), or cause a character to depart from the presentation (e.g. frog hops away).

The activation or deactivation of a stream of content may also change an internal property or characteristic of an object in the presentation. For example, activation of a particular stream may cause the mood of a character, such as the prince, to change from happy to sad. Such a change may become evident immediately in the presentation (e.g., the prince's smile becomes a frown), or may not be apparent until later in the presentation. Such internal changes are not limited to characters, and may apply to any object that is part of the presentation, which contains some characteristic or parameter that can be changed.

In step 120, the set-top box decodes the extracted scene data. The setting is displayed on a television screen, along with some indication to the user that he or she must determine how the story proceeds by manipulating the input device 30. This step may also present instructions that indicate to the user the types of manipulations that will activate or deactivate certain streams of content. As a result, the user manipulates the input device 30 as shown in step 130.

In step 140, the sensors 330 of the input device 30 detect the user manipulation(s) and send the resulting detection signals to the microprocessor, which maps these signals to a manipulation code. In step 150, the manipulation code is transmitted to the set-top box, which determines the streams of content that are linked to the code and subsequently activated or deactivated. Therefore, according to the manipulations of the input device, one or more different actions or events may occur in the narrative presentation.

In step 160, the new storyline is played out on the television according to the activated/deactivated streams of content. In this particular example, each stream of content is an MPEG file, which is played on the television while activated.

The set-top box determines whether the activated streams of content necessarily cause the storyline to progress to a new scene in step 170. If so, the process returns to step 110 to receive the streams of content corresponding to the new scene. However, if a new scene is not necessitated by the storyline, the set-top box determines whether the narrative has reached a suitable ending point in step 180. If this is not the case, the user is instructed to use the user interface 30 in order to activate or deactivate streams of content and thereby continue the story. The flowchart of FIG. 6 and the corresponding description above is meant to describe an exemplary embodiment, and is in no way limiting.

The present invention provides a system that has many uses in the developmental education of children. The present invention promotes creativity and development of communication skills by allowing children to express themselves by interacting with and adapting a presentation or narrative. Children will find using the input device 30 of the present invention easy to use and intuitive, since all that is required is simple actions that children are familiar with, such as rolling or bouncing the device. Also, the input device 30 can be embodied as an object that a young child is very familiar with, such as a ball or a toy. The playful nature of the input device 30 further provides children with motivation to interact with the present invention.

It should be noted, however, that the input device 30 of the present invention is in no way limited in its use to children, nor is it limited to educational applications. The present invention provides an intuitive and stimulating interface to interact with many different kinds of presentations geared to users of all ages.

A user can have a variety of different types of interactions with the presentation by utilizing the present invention. As mentioned above, the user may affect the outcome of a narrative presentation by causing characters to perform certain types actions or by initiating certain events that affect the setting and all of the characters therein, such as a natural disaster or a weather storm. The input device 30 can also be used to merely change details within the setting, such as changing the color of a building or the number of trees in a forest. However, the user is not limited to interacting with presentations that are narrative by nature. The input device 30 can be used to choose elements to be displayed in a picture, to determine the lyrics to be used in a song or poem, to take one's turn in a game, to interact with a computer simulation, or to perform any type of interaction that permits self-expression within a presentation.

The user's interactions may have a very logical connection to the manipulations required by the input device 30. For example, the input device 30 may be used for a computer-simulated game or sport that requires an action similar to the manipulation of the device. Examples include rolling an input device 30 shaped like a ball to simulate the rolling of a bowing ball down an alley, or bouncing the same device to simulate the dribbling of a basketball. Similarly, other objects may be used in conjunction with the input device 30 to cause the manipulations. A cue stick or a golf club may be used to hit a ball-shaped input device 30 to simulate a game of pool or golf, respectively.

In addition, the user interface 30 of the present invention is not limited to an input device 30 that is shaped like a ball. The present invention covers any type of input device 30 having a form such that it is easily manipulated in a variety of ways, such as a toy block a wheel, or a stick.

The types of manipulations that can be performed on the input device 30 is not limited to those described above. They may include any manner of manipulation that can be distinguished by a set of sensors. For example, the sensors 330 may include a Global Positioning System receiver, and the manipulation codes may correspond to different locations where the input device 30 has been taken. In this embodiment, the end-user device 10 and the display device 15 may be incorporated with the input device 30 as a portable device, which displays real-time traffic, weather, and news information corresponding to the location represented by the determined manipulation code.

The present invention has been described with reference to the exemplary embodiments. As will be evident to those skilled in the art, various modifications of this invention can be made or followed in light of the foregoing disclosure without departing from the scope of the claims.

1. An input device for an interactive system that receives and transforms streams of content into a presentation to be output according to a manipulation of said input device, comprising:
at least one sensor which generates at least one detection signal corresponding to a detected manipulation of said input device;
a microprocessor that maps the at least one detection signal to a coded signal representative of the detected manipulation, and transmits said coded signal to said interactive system.

2. The input device according to claim 1, wherein the at least one sensor includes at least one of a light sensor, a rotation sensor, and a touch sensor.

3. The input device according to claim 1, wherein said coded signal indicates a type of manipulation corresponding to said detected manipulation.

4. The input device according to claim 3, wherein said indicated type of manipulation is chosen from a set of manipulation types including at least one of: rotation, rolling, bouncing, throwing, shaking, and covering with a cloth.

5. The input device according to claim 1, having a spherical shape and being divided into a first and second hemisphere, wherein said indicated type of manipulation is chosen from a set including rotation of the first hemisphere with respect to the second hemisphere.

6. The input device according to claim 1, wherein said coded signal is transmitted to said interactive system via radio signals.

7. The input device according to claim 1, wherein said presentation includes a narrative.

8. The input device according to claim 1, wherein one or more streams of content are activated or deactivated in said presentation based on said coded signal.

9. A process in a system for transforming streams of content into a presentation to be output, comprising:
sensing a manipulation at an input device;
mapping said sensed manipulation to a manipulation code;
associating said manipulation code to one or more of said streams of content; activating or deactivating said one or more associated streams of content in said presentation.

10. A system comprising:
an end-user device for receiving and transforming streams of content into a presentation;
an input device including one or more sensors and a microprocessor, said microprocessor mapping detection signals from said one or more sensors to one or more manipulation codes, and
an output device for outputting the presentation,
wherein said end-user device activates or deactivates streams of content in said presentation based on said one or more mapped manipulation codes.
